(19) United States
(12) Patent Application Publication
(10) Pub. No.: US 2006/0274937 A1
(43) Pub. Date: Dec. 7, 2006

(54) Apparatus and method for adjusting colors of a digital image

(76) Inventors: Eric Jeffrey, Richmond (CA); Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/146,505

(22) Filed: Jun. 7, 2005

(51) Int. Cl. G06K 9/00

(52) U.S. Cl. 382/169

(57) ABSTRACT

A graphics controller for adjusting contrast of a digital image is provided. The graphics controller includes a graphics controller memory configured for storing a histogram table and a contrast adjustment module in communication with the graphics controller memory. The contrast adjustment module is configured to read frequency values from the histogram table and to generate a histogram equalization function based on the frequency values. Furthermore, the contrast adjustment module is configured to apply the histogram equalization function to the digital image. A hardware implemented method for adjusting the contrast of the digital image and a contrast adjustment module are also described.

### CROSS REFERENCE TO RELATED APPLICATIONS

This application is related to U.S. patent application Ser. No. 10/934,957 (Attorney Docket No. VP 141), filed on Sep. 3, 2004, and entitled “Apparatus and Method for Histogram Stretching,” the disclosure of which is incorporated herein by reference.

### BACKGROUND

Contrast within a digital image, such as that captured by a digital camera, can be adjusted to improve the color and clarity of the digital image. If the digital image has insufficient contrast, features and details of the image may be indistinguishable from other portions of the digital image. Therefore, evaluation and adjustment of the contrast may be useful prior to display.

One method for evaluating the contrast of a digital image includes the use of a histogram table. The histogram table represents a frequency of occurrence of each pixel value within the digital image. Therefore, evaluation of the histogram table can identify similar pixel values that occur with sufficient frequency in the image such that contrast is adversely affected. A central processing unit (CPU) outside a graphics controller is typically used to calculate the contrast adjustments based on the information gleaned from the histogram table. Such contrast calculations and adjustments can utilize a large amount of CPU processing power and valuable bandwidth.

In view of the foregoing, there is a need to provide a method and an apparatus to more efficiently process contrast adjustment calculations that utilize less CPU bandwidth.

### SUMMARY

Broadly speaking, the present invention fills these needs by providing hardware implemented methods and apparatuses for adjusting contrast of a digital image. It should be appreciated that the present invention can be implemented in numerous ways, including as a method, a system, or a device. Several inventive embodiments of the present invention are described below.

In accordance with a first aspect of the present invention, a hardware implemented method for adjusting contrast of a digital image is provided. In this method, a histogram table stored in a memory of a graphics controller is read. A normalized cumulative histogram based on the histogram table is calculated. A histogram equalization transfer function based on the normalized cumulative histogram is generated and the histogram equalization transfer function is written into a look-up-table of the graphics controller to adjust the contrast of the digital image. It should be appreciated that the method operations of reading the histogram table, calculating the normalized cumulative histogram, generating and writing the histogram equalization transfer function are all executed within the graphics controller.

In accordance with a second aspect of the present invention, a contrast adjustment module of a graphics controller is provided. The contrast adjustment module includes circuitry for reading a frequency value from a histogram table and for calculating a cumulative histogram value based on the frequency value. Also included are circuitry for normalizing the cumulative histogram value and circuitry for writing the normalized cumulative histogram value to a look-up-table.

In accordance with a third aspect of the present invention, a graphics controller for adjusting contrast of a digital image is provided. The graphics controller includes a graphics controller memory configured for storing a histogram table and a contrast adjustment module in communication with the graphics controller memory. The contrast adjustment module is configured to read frequency values from the histogram table and to generate a histogram equalization function based on the frequency values. Furthermore, the contrast adjustment module is configured to apply the histogram equalization function to the digital image.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIGS. 1A, 1B, 1C, and 1D are illustrations of exemplary digital images and corresponding histograms of the exemplary digital images.

FIG. 2 is a simplified schematic diagram of an apparatus for adjusting the contrast of a digital image, in accordance with one embodiment of the present invention.

FIG. 3 is a simplified schematic diagram of the graphics controller shown in FIG. 2, in accordance with one embodiment of the present invention.

FIG. 4 is a more detailed schematic diagram of the contrast adjustment module shown in FIG. 3, in accordance with one embodiment of the present invention.

FIG. 5 is a high level flowchart illustrating the method operations for adjusting the contrast of a digital image, in accordance with one embodiment of the present invention.

### DETAILED DESCRIPTION

An invention is described for hardware implemented methods and apparatuses for adjusting contrast of a digital image. It will be obvious, however, to one skilled in the art, that the present invention may be practiced without some or all of these specific details. In other instances, well known process operations have not been described in detail in order not to unnecessarily obscure the present invention.

The embodiments described herein provide apparatuses and hardware implemented methods for adjusting contrast of a digital image. A graphics controller includes a contrast adjustment module that performs histogram equalization to adjust the contrast of the digital image. In one embodiment, the contrast adjustment module initially reads frequency values from a histogram table. As will be explained in more detail below, the contrast adjustment module then generates a histogram equalization function based on the frequency values and applies the histogram equalization function to the digital image.

A digital image is created by mapping a captured image onto a grid of picture elements or pixels. Each pixel is assigned a pixel value, i.e., tonal value, that most closely corresponds to a portion of the captured image that the pixel is intended to represent. In digital imaging, the pixel value is represented as a binary code defined by a sequence of binary digits. The number of binary digits used to define each pixel value represents a bit depth of the digital image. A larger bit depth corresponds to a larger set of possible pixel values that can be used to define each pixel in the digital image. For example, in a black and white image having a bit depth of one, there are 2or two possible pixel values that can be assigned to each pixel. In a gray scale or color image having a bit depth of eight, there are 28 or 256 possible pixel values available for assignment to each pixel. Furthermore, a digital image having a bit depth of sixteen will have 216 or 65,536 possible pixel values for each pixel. It should be appreciated that the present invention can be implemented in conjunction with any bit depth, including bit depths not explicitly identified herein.

The pixel values used to define a digital image can also be used to evaluate properties of the digital image, such as contrast. For example, a digital image that includes a large number of pixels having the same or similar pixel value may be identified as having low contrast, consequently obscuring features or details within the digital image. Information obtained from analyzing the pixel values of the digital image can be used to refine/improve the digital image properties prior to display.

One approach for analyzing the pixel values of the digital image is to develop a histogram table for the digital image, whereby the histogram table represents a frequency of occurrence of each possible pixel value in the digital image. In the histogram table, a tally (i.e., a frequency value) is generated for each possible pixel value based on the bit depth of the digital image. Each tally represents a frequency of occurrence of its corresponding pixel value in the digital image. Thus, each pixel in the digital image having a particular pixel value will contribute one count to the tally for the particular pixel value. Once each pixel in the digital image is appropriately tallied into the histogram table, the histogram table can be evaluated to identify contrast issues and to improve the digital image as necessary prior to display.

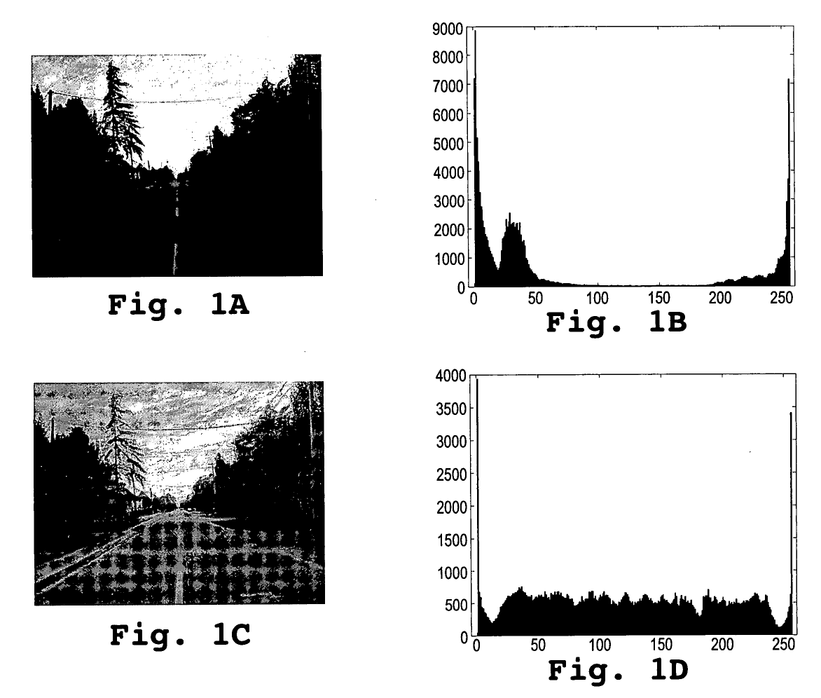

FIG. 1A is an illustration of an exemplary digital image having low contrast and FIG. 1B is a graph of a corresponding histogram of the low contrast digital image. As shown in FIG. 1B, the digital image of FIG. 1A has a bit depth of eight, with 256 possible pixel values represented as zero through 255 on the horizontal axis. The vertical axis represents a frequency of occurrence of each pixel value within the digital image. As demonstrated by the histogram graph of FIG. 1B, a digital image having low contrast can have many pixel values that are used infrequently or not at all. The infrequent use means that the majority of the digital image is composed of pixel values clustered around a limited amount of pixel values. For example, as shown in FIG. 1B, the majority of the pixel values are at the absolute minimum (i.e., zero) and maximum (i.e., 255). The close grouping of the pixel values makes it difficult for an observer to resolve any details in the digital image.

One approach for improving the contrast of a digital image is to implement a histogram equalization technique on the pixel values that define the digital image. Essentially, the goal of histogram equalization is to obtain a uniform histogram. In particular, histogram equalization redistributes pixel values such that the pixel values are uniformly spread. If the histogram has any peaks and valleys, the histogram may still have peaks and valleys after histogram equalization, but the peaks and valleys will be shifted or smoothed. For instance, FIG. 1C is an illustration of the exemplary FIG. 1A digital image following the application of the histogram equalization technique, and FIG. 1D is a graph of a corresponding histogram of the FIG. 1C digital image. When compared with the histogram graph of FIG. 1B, histogram graph of FIG. 1D shows that the pixel values are more evenly distributed as a result of the application of the histogram equalization. The histogram graph of FIG. 1D shows that a broad range of possible pixel values are well represented in the digital image. As a result, more details are discernable in the digital image of FIG. 1C than the digital image of FIG. 1A. Thus, histogram equalization can be applied to a digital image to improve the contrast of the digital image.

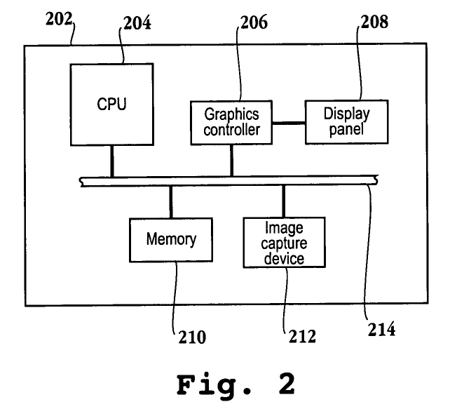

FIG. 2 is a simplified schematic diagram of an apparatus for adjusting the contrast of a digital image, in accordance with one embodiment of the present invention. Apparatus 202 may represent any suitable type of computing device. For example, apparatus 202 may be a personal digital assistant, a cell phone, a web tablet, a pocket personal computer, a portable electronic computing device, etc. As shown in FIG. 2, apparatus 202 includes central processing unit (CPU) 204, memory 210, graphics controller 206, display panel 208, and image capture device 212. Graphics controller 206 is in communication with CPU 204, memory 210, display panel 208, and image capture device 212. One skilled in the art will appreciate that CPU 204, memory 210, graphics controller 206, and image capture device 212 may be in communication through common bus 214.

Image capture device 212 (e.g., digital video camera, digital camera, etc.) records photographic images as image data and outputs the raw image data to graphics controller 206 for display on display panel 208. Graphics controller 206 is a component of apparatus 202 that is designed to convert a logical representation of a digital image stored in memory 210 or captured from image capture device 212 to a signal that can be used as input for display panel 208. Exemplary graphics controller 206 includes a liquid crystal display controller (LCDC), mobile graphics controllers, etc. Display panel 208 may include random access memory (RAM) integrated display panels, liquid crystal displays (LCD), thin-film transistor (TFT) displays, cathode ray tube (CRT) monitors, televisions, etc. Furthermore, apparatus 202 includes CPU 204 that processes the basic instructions that drive the apparatus, and the apparatus additionally includes memory 210 (e.g., static random access memory (SRAM), dynamic random access memory (DRAM), etc.) that is configured to store data and instructions.

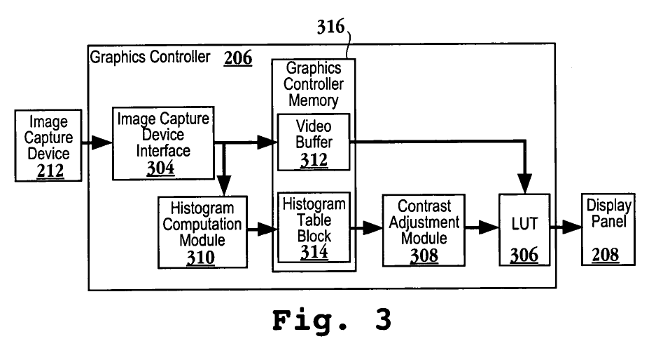

FIG. 3 is a simplified schematic diagram of the graphics controller shown in FIG. 2, in accordance with one embodiment of the present invention. As shown in FIG. 3, graphics controller 206 includes image capture device interface 304, look-up-table (LUT) 306, contrast adjustment module 308, histogram computation module 310, and graphics controller memory 316. Image capture device interface 304 is configured to receive digital image data from image capture device 212. It should be appreciated that image capture device interface 304 receives digital image data from image capture device 212 as a stream of bytes. The digital image data arrives at image capture device interface 304 in pixel order according to a raster sequence. For example, the digital image data arriving at image capture device interface 304 can represent streaming video from a digital video camera or a single snapshot from a digital camera. With streaming video, each arriving frame of video can be considered as a single digital image, similar to a single snapshot arriving from a digital camera. Since a histogram table is generated on a single digital image basis, the present embodiments are described in terms of receiving and processing data for a single digital image.

Histogram computation module 310 provides the functionality to generate a histogram table used for evaluating the contrast of the digital image. During operation, a histogram table can be generated for each incoming digital image or for selected incoming digital images. Whenever a histogram is to be generated for an incoming digital image, the digital image data is transmitted from image capture device interface 304 to histogram computation module 310. Histogram computation module 310 operates to determine the frequency value for each incoming pixel value, and stores the frequency value for each pixel value in histogram table block 314 of graphics controller. memory 316. In other words, histogram computation module 310 generates the histogram table based on digital image data received from image capture device interface 304, and stores the histogram table in histogram table block 314 of graphics controller memory 316. Instead of receiving the digital image from image capture device interface 304, it should be appreciated that histogram computation module 310 can also receive a digital image transmitted from a CPU (as shown in FIG. 2) in communication with graphics controller 206.

Once the entirety of the digital image data has been processed by histogram computation module 310, contrast adjustment module 308 retrieves the histogram table from histogram table block 314 and analyzes the histogram table to determine appropriate adjustments to subsequent digital images. As shown in FIG. 3, contrast adjustment module 308 is incorporated into graphics controller 206 and the contrast adjustment module includes circuitry for adjusting the contrast of a digital image. As will be explained in more detail below, in one exemplary embodiment, contrast adjustment module 308 includes circuitry for reading a frequency value from a histogram table stored in histogram table block 314 and circuitry for calculating a normalized cumulative histogram based on the histogram table. Additionally included is circuitry for generating a histogram equalization transfer function based on the normalized cumulative histogram and circuitry for writing the histogram equalization transfer finction into LUT 306 to adjust the contrast of the digital image.

As shown in FIG. 3, LUT 306 is in communication with contrast adjustment module 308 and video buffer 312. It will be apparent to one skilled in the art that LUT 306 is a table of cross-references that links pixel values to output red, green, and blue color component values. LUT 306 is used to quickly determine the colors and intensity values with which a particular digital image will be displayed. The translated color component values from LUT 306 are then directed to display panel 208. FIG. 3 shows LUT 306 is a separate piece of memory, i.e., another memory instance, that acts as a translation table. However, graphics controller memory 316 and LUT 306 may be integrated into the same memory. Since LUT values basically control the color of the digital image, the contrast of the digital image can be adjusted by modifying the LUT values stored in LUT 306. As a result, contrast adjustment module 308 is configured to generate and to write a histogram equalization transfer function to adjust the contrast of the digital image. After contrast adjustment module 308 modifies LUT 306, contrasts of subsequent digital images received from video buffer 304 are adjusted according to the modified LUT values. One skilled in the art will appreciate that video buffer 312 included in graphics controller memory 316 stores the digital image for display panel 208, and functions as a buffer between a CPU or image capture device 212 and display panel 208.

It should be appreciated that contrast adjustment module 308 can be configured such that the contrast adjustment module does not analyze the histogram table for every frame. For example, in one embodiment, contrast adjustment module 308 may analyze the histogram table once every thirty frames. As a result, the modified LUT values will be applied to each subsequent frame until contrast adjustment module 308 makes another modification to LUT 306.

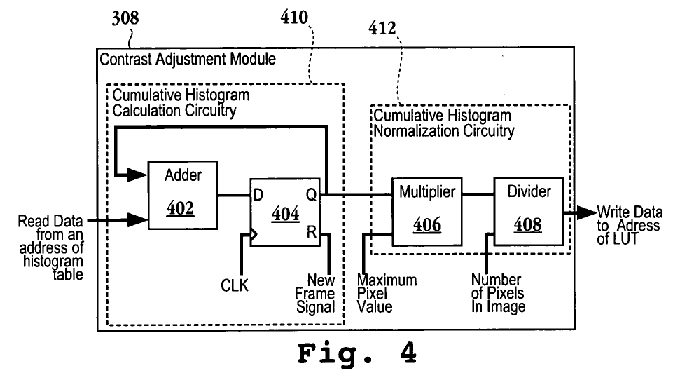

FIG. 4 is a more detailed schematic diagram of the contrast adjustment module shown in FIG. 3, in accordance with one embodiment of the present invention. In one embodiment, the histogram equalization transfer function is generated by calculating a cumulative histogram value and normalizing the cumulative histogram value. Specifically, the cumulative histogram for any pixel value p is defined as:

$$C ( p ) = {\sum }_{r = 0}^{p} H ( r ) \qquad ( 1.0 )$$

With reference to equation (1.0), H(r) is the histogram table entry for pixel value r. The cumulative histogram function is generated by normalizing the cumulative histogram:

$$\overline{C} ( p ) = C ( p ) ( \frac{max\_pixel \_value}{number\_of \_pixels} ) \qquad ( 1.2 )$$

With reference to equation (1.2), max_pixel_value is the maximum pixel value, and is defined by 2^{N}−1, whereby the N represents the bit depth. For example, the maximum pixel value of an eight bit digital image is (2⁸−1) or 255. Number of pixels is the number of pixels in the digital image (i.e., number of pixels along a width of the digital image*number of pixels along a height of the digital image). For example, the number of pixels in a 512×512 digital image is 262,144.

As shown in FIG. 4, to generate a histogram equalization transfer function of equation (1.2), contrast adjustment module 308 includes cumulative histogram calculation circuitry 410 and cumulative histogram normalization circuitry 412. In one embodiment, cumulative histogram calculation circuitry 410 includes adder 402 in communication with storage circuit 404 (e.g., a delay flip-flop). Adder 402 is configured to add a frequency value to a previously calculated cumulative histogram value to output a cumulative histogram value, and storage circuit 404 is configured to temporarily store the cumulative histogram value. For example, contrast adjustment module 308 includes well-known circuitry for reading a first frequency value from a first address of the histogram table and supplying the first frequency value to adder 402. Adder 402 then adds the first frequency value to a previously calculated cumulative histogram value. The previous cumulative histogram value is zero because, initially, nothing is stored in storage circuit 404. Adder 402 then outputs the first frequency value to storage circuit 404 for storage. Thereafter, adder 402 reads a second frequency value from a second address of the histogram table and calculates a cumulative histogram value by adding the second frequency value to the first frequency value that is read from storage circuit 404.

In other words, the cumulative histogram value is the sum of the second frequency value and the first frequency value. Adder 402 then overwrites the first frequency value stored in storage circuit 404 with the calculated cumulative histogram value. The above-described operations may be repeated for each frequency value stored in histogram table to calculate a corresponding cumulative histogram value as defined by equation (1.0). It should be appreciated that storage circuit 404 can have a reset that is connected to a NewFrame signal. In one embodiment, the NewFrame signal goes high for one clock pulse at the beginning of any new frame to reset the value of storage circuit 404 back to zero.

After the cumulative histogram value is calculated, cumulative histogram calculation circuitry 410 sends the cumulative histogram value to cumulative histogram normalization circuitry 412 for normalization. As shown in FIG. 4, in one embodiment, cumulative histogram normalization circuitry 412 includes multiplier 406 in communication with divider 408. Multiplier 406 is configured to receive the cumulative histogram value and to multiply the cumulative histogram value with a maximum pixel value. Divider 408 is configured to receive the multiplier output (i.e., multiplication product) and to calculate a normalized cumulative histogram value by dividing the multiplier output by a number of pixels in the digital image. Divider 408 then outputs the normalized cumulative histogram value. Contrast adjustment module 308 includes well-known circuitry to write the normalized cumulative histogram value to a LUT, such as LUT 306 of FIG. 3, whereby the original LUT value is overwritten with the cumulative histogram value to adjust the contrast of the digital image.

It should be appreciated that the maximum pixel value and the number of pixels in the digital image that are inputted into multiplier 406 and divider 408, respectively, can be stored in registers, whereby the registers can be set by a user through a CPU. In this embodiment, the CPU's involvement with the contrast adjustment operations of the graphics controller is limited to enabling the user to set values in the registers. Such registers can reside at essentially any suitable location within the graphics controller. For example, the registers can be located in a register block of the graphics controller or within contrast adjustment module 308.

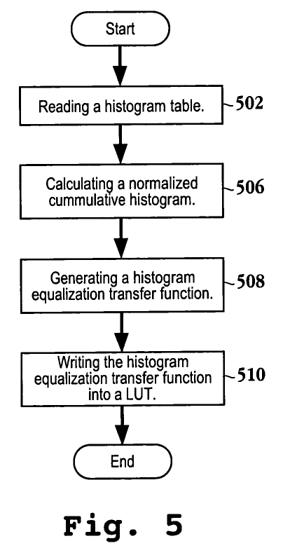

FIG. 5 is a high level flowchart illustrating the method operations for adjusting the contrast of a digital image, in accordance with one embodiment of the present invention. Starting in operation 502, a histogram table stored in a graphics controller memory is read. Thereafter, a normalized cumulative histogram is calculated in operation 506 based on the histogram table. As discussed above, to calculate the normalized cumulative histogram, a cumulative histogram first is calculated by essentially adding frequency values read from the histogram table. Thereafter the cumulative histogram is normalized to define the normalized cumulative histogram. A histogram equalization transfer function then is generated in operation 508 based on the normalized cumulative histogram, and the histogram equalization transfer function is written into a LUT of the graphics controller in operation 510 to adjust the contrast of the digital image. It should be appreciated that operations 502-510 are executed with the graphics controller, thereby freeing up the CPU to process other instructions.

In summary, the above-described invention provides apparatuses and hardware implemented methods for adjusting the contrast of a digital image. Essentially, histogram equalization is computed entirely inside the graphics controller. Thus, the graphics controller is configured to offload the generation of the histogram equalization function from a central processing unit that is in communication with the graphics controller. The offload of the histogram equalization processing from a CPU to the graphics controller lessens the CPU processing load and reduces power consumption by reducing the amount of input/output pin toggling between the CPU and graphics controller. Accordingly, the above-described embodiments process contrast adjustment calculations more efficiently and utilize less CPU bandwidth.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for adjusting contrast of a digital image, comprising method operations of:
a. reading a histogram table stored in a memory of a graphics controller;
b. calculating a normalized cumulative histogram based on the histogram table;
C. generating a histogram equalization transfer function based on the normalized cumulative histogram; and
d. writing the histogram equalization transfer function into a look-up-table of
the graphics controller to adjust the contrast of the digital image, wherein the method operations a-d are executed within the graphics controller.

2. The hardware implemented method of claim 1, wherein the method operation of calculating the normalized cumulative histogram includes,
calculating a cumulative histogram based on the histogram table; and
normalizing the cumulative histogram.

3. The hardware implemented method of claim 2, wherein the method operation of calculating the cumulative histogram includes,
adding frequency values read from the histogram table.

4. The hardware implemented method of claim 2, wherein the method operation of normalizing the cumulative histogram includes,
multiplying a sum of frequency values read from the histogram table with a maximum pixel value to define a multiplication product; and
dividing the multiplication product by a number of pixels in the digital image.

5. A contrast adjustment module of a graphics controller, comprising:
circuitry for reading a frequency value from a histogram table;
circuitry for calculating a cumulative histogram value based on the frequency value;
circuitry for normalizing the cumulative histogram value; and
circuitry for writing the normalized cumulative histogram value to a look-up-table.

6. The contrast adjustment module of claim 5, wherein the circuitry for calculating the cumulative histogram value includes,
an adder configured to add the frequency value to a previously calculated cumulative histogram value to define a sum representing the cumulative histogram value; and
a storage circuit in communication with the adder, the storage circuit being configured to temporarily store the cumulative histogram value.

7. The contrast adjustment module of claim 6, wherein the storage circuit is a delay flip-flop.

8. The contrast adjustment module of claim 5, wherein the circuitry for normalizing the cumulative histogram value includes,
a multiplier configured to multiply the cumulative histogram value with a maximum pixel value to define a multiplier output; and
a divider in communication with the multiplier, the divider being configured to divide the multiplier output received from the multiplier by a number of pixels in the digital image.

9. The contrast adjustment module of claim 8, wherein the maximum pixel value is defined as one subtracted from two to an exponent of a bit depth.

10. The contrast adjustment module of claim 8, wherein the number of pixels in the digital image is a number of pixels in a width of the digital image multiplied by a number of pixels in a height of the digital image.

11. The contrast adjustment module of claim 5, wherein the contrast adjustment module is incorporated into one of a personal digital assistant, a cell phone, a web tablet, or a pocket personal computer.

12. A graphics controller for adjusting contrast of a digital image, comprising:
a graphics controller memory configured for storing a histogram table; and
a contrast adjustment module in communication with the graphics controller memory, the contrast adjustment module being configured to read frequency values from the histogram table, the contrast adjustment module being further configured to generate a histogram equalization function based on the frequency values and to apply the histogram equalization function to the digital image.

13. The graphics controller of claim 12, wherein the contrast adjustment module includes,
an adder configured to add the frequency values to define a cumulative histogram value;
a storage circuit in communication with the adder, the storage circuit being configured to temporarily store the cumulative histogram value;
a multiplier in communication with the storage circuit, the multiplier being configured to multiply the cumulative histogram value and a maximum pixel value to define a multiplier output; and
a divider in communication with the multiplier, the divider being configured to divide the multiplier output received from the multiplier by a number of pixels in the digital image.

14. The graphics controller of claim 13, wherein the storage circuit is a delay flip-flop.

15. The graphics controller of claim 12, further comprising:
a look-up-table in communication with the contrast adjustment module and a video buffer, wherein the histogram equalization function is written to the look-up-table.

16. The graphics controller of claim 12, further comprising:
an image capture device interface in communication with a video buffer and a histogram computation module.

17. The graphics controller of claim 12, further comprising:
a histogram computation module in communication with the graphics controller memory, the histogram computation module being configured to calculate the histogram table.

18. The graphics controller of claim 12, wherein the graphics controller is incorporated into a portable electronic computing device.

19. The graphics controller of claim 12, wherein the graphics controller is configured to offload the generation of the histogram equalization function from a central processing unit in communication with the graphics controller.
